(19) United States
(12) Patent Application Publication
(10) Pub. No.: US 2026/0305613 A1
(43) Pub. Date: Oct. 8, 2026

(54) COMPOSITION FOR MOISTURIZING MOSS AND IMPROVING WATER RETENTION CAPABILITY

(71) Applicant: CODE OF NATURE CO., LTD., Yangsan-si (KR)

(72) Inventors: Doyeon KIM, Seoul (KR); Jaehong PARK, Seoul (KR)

(21) Appl. No.: 19/398,051

(22) Filed: Nov. 24, 2025

Related U.S. Application Data
(63) Continuation of application No. PCT/KR2025/018650, filed on Nov. 12, 2025.

(30) Foreign Application Priority Data
Apr. 2, 2025 (KR) 10-2025-0042561

(51) Int. Cl. A01N 59/06; A01N 59/14; A01N 59/20; A01N 59/26; A01P 21/00

(52) U.S. Cl. CPC A01N 59/06; A01N 59/14; A01N 59/20; A01N 59/26; A01P 21/00

(57) ABSTRACT

The present invention relates to a composition for moisturizing moss and improving water retention capability. Through the composition of the invention, water is supplied to moss to impart a moisturizing effect, while the water retention capability of moss is enhanced so that water required for moss physiological activities can be stably supplied; accordingly, even in dry environments, efficiency of moss growth and reproduction can be increased.

### TECHNICAL FIELD

The present invention relates to a composition for moisturizing moss and improving water retention capability, and more particularly to a composition that, while supplying water to moss so as to moisturize moss tissues, can also enhance the water retention capability of moss, and to a method for moisturizing moss and improving water retention capability using the same.

### BACKGROUND ART

Bryophytes are non-vascular plants lacking vascular bundles and undergo an alternation of generations between spores and a sporophyte and a gametophyte. Bryophytes include commonly known mosses as well as liverworts and hornworts; this classification is at the phylum level: mosses belong to Bryophyta, liverworts to Marchantiophyta, and hornworts to Anthocerotophyta. More than 20,000 species of bryophytes have been identified to date, and they occur in nearly all terrestrial regions from tropical rainforests to polar tundra, excluding the oceans.

As non-vascular plants with rhizoids, mosses lack roots and conductive tissues that absorb water and nutrients from soil or substrate and deliver them to various tissues; instead, they must absorb water and nutrients directly from the surrounding environment for growth, reproduction, and other physiological activities. Therefore, uptake and retention of water are essential for growth and survival of mosses, which have evolved toward improved water retention capability.

Based on their ability to absorb and retain water, mosses can hold water in their bodies when the environment is humid and release moisture when the surroundings become dry, thereby supplying humidity; through this process, they regulate small ecosystems and help other organisms thrive.

However, when a dry state persists for an extended period, most of the water stored in moss tissues is lost, and growth may slow or cease; accordingly, in growing or cultivating moss, it is desirable to supply sufficient water to the moss.

Conventionally, simply spraying water has been widely used to supply water to moss; however, in such cases the supplied water evaporates rapidly, resulting in insufficient moisturizing, and the water absorbed by the moss is quickly released from moss tissues.

Therefore, there is a need for a new nutrient solution that can effectively supply water to moss even in dry environments while enabling moss to retain absorbed water for a prolonged period.

### SUMMARY

### Technical Problem

The inventors have confirmed that, when a composition containing predetermined nutrient elements is applied to moss, the moss can be supplied with water to exhibit a moisturizing effect and, at the same time, can retain water for an extended period.

Accordingly, it is an object of the present invention to provide a composition for moisturizing moss and improving water retention capability that contains predetermined nutrient elements.

Another object of the invention is to provide a method of moisturizing moss and improving water retention capability by means of a composition containing predetermined nutrient elements.

### Solution to Problem

The present invention relates to a composition for moisturizing moss and improving water retention capability; through the composition of the invention, a moisturizing effect is imparted to moss and the water retention capability of moss is enhanced, thereby enabling stable supply of the water required for moss physiological activities even in dry environments, so that moss can effectively grow and reproduce.

Details of the invention are described below.

In one aspect, the invention provides a composition for moisturizing moss and improving water retention capability comprising: an A-part including metal nitrate(s) and an iron chelate compound; and a B-part including metal nitrate(s), metal sulfate(s), phosphate(s), a boron compound, and a molybdenum compound.

In the present invention, the term “moss” encompasses not only mosses classified taxonomically as Bryophyta, but also liverworts classified as Marchantiophyta and hornworts classified as Anthocerotophyta; as used herein, “moss” may be used interchangeably with “bryophyte(s).”

The composition of the invention may be applied to any bryophyte species belonging to Bryophyta, Marchantiophyta, or Anthocerotophyta; examples include, for Bryophyta: Polytrichum commune, Sphagnum palustre, Hypnum plumaeforme, Hypnum cupressiforme, Dicranum scoparium, Ulota crispa, Bryum argenteum, Plagiomnium cuspidatum, Rhizomnium punctatum, Leucobryum glaucum, Climacium dendroides, Ceratodon purpureus, or Thuidium kanedae; for Marchantiophyta: Marchantia polymorpha, Conocephalum conicum, Riccia fluitans, Pellia epiphylla, or Lunularia cruciata; and for Anthocerotophyta: Anthoceros punctatus, Phaeoceros laevis, Notothylas orbicularis, Megaceros flagellaris, or Gollania varians, without limitation.

As used herein, “moisturizing” means supplying water to moss tissues or to growth substrates such as soil or media on which moss grows, thereby causing moss to absorb water directly or indirectly while suppressing water loss or evaporation from moss tissues and the growth substrate, so as to maintain the hydration environment in which the moss grows.

As used herein, “water retention capability” means the capability of moss to maintain/hold water for a certain period after direct or indirect water supply to the moss body so as to sustain normal physiological activity; moss may exhibit water retention capability through physiological desiccation tolerance and rehydration capacity.

Accordingly, “improving moisturizing and water retention capability,” as used herein, may refer to enabling moss, relative to the untreated natural state, to utilize water for physiological activities for a longer period by supporting or improving, from the water supply to suppression of water loss and evaporation from the moss body or growth substrate and the desiccation tolerance and rehydration capacity of moss.

In the present invention, the metal nitrate(s), metal sulfate(s), boron compound, and molybdenum compound may be used in hydrated (X·nH₂O) or anhydrous (X) forms, and may be in powder or crystalline form or as a solution diluted/dissolved in a solvent. Likewise, the iron chelate compound may be used in hydrated or anhydrous form and, as a hydrate or anhydrous salt with sodium, potassium, or ammonium ions added to improve compound stability and water solubility, may be in powder, crystalline, or solution form. The phosphate(s) may also be used in hydrated or anhydrous form depending on hydrophilicity and stability, and may be in powder, crystalline, or solution form.

In one embodiment, the metal nitrate(s) of the A-part are one or more anhydrous or hydrated forms selected from potassium nitrate (KNO₃), calcium nitrate (Ca(NO₃)₂), and magnesium nitrate (Mg(NO₃)₂), and the iron chelate compound is one or more selected from FeEDTA, FeDTPA, FeEDDHA, FeHEEDTA, ferric citrate, and ammonium ferric citrate.

In one embodiment, the A-part includes 40 to 80 g/L of the metal nitrate(s) and 0.9 to 3.5 g/L of the iron chelate compound.

In one embodiment, the metal nitrate(s) of the A-part includes 8 to 15 g/L of potassium nitrate, 12 to 24 g/L of calcium nitrate, and 21 to 42 g/L of magnesium nitrate.

In one embodiment, the metal nitrate(s) of the B-part are potassium nitrate; the metal sulfate(s) are one or more anhydrous or hydrated forms selected from magnesium sulfate (MgSO₄), manganese sulfate (MnSO₄), zinc sulfate (ZnSO₄), and copper sulfate (CuSO₄); the phosphate(s) are one or more selected from ammonium dihydrogen phosphate (NH₄H₂PO₄), diammonium hydrogen phosphate ((NH₄)₂HPO₄), and potassium dihydrogen phosphate (KH₂PO₄); the boron compound is an anhydrous or hydrated forms of sodium tetraborate (borax, Na₂B₄O₇) or boric acid (H₃BO₃); and the molybdenum compound is an anhydrous or hydrated forms of ammonium molybdate ((NH₄)₆Mo₇O₂₄) or sodium molybdate (Na₂MoO₄).

In one embodiment, the B-part includes 8 to 15 g/L of the metal nitrate(s), 2 to 7 g/L of the metal sulfate(s), 15 to 25 g/L of the phosphate(s), 0.05 to 0.2 g/L of the boron compound, and 0.0008 to 0.0016 g/L of the molybdenum compound.

In one embodiment, the metal sulfate(s) of the B-part include 2 to 7 g/L of magnesium sulfate, 0.05 to 0.1 g/L of manganese sulfate, 0.003 to 0.012 g/L of zinc sulfate, and 0.002 to 0.006 g/L of copper sulfate.

The amounts of the metal nitrate(s), iron chelate compound, metal sulfate(s), phosphate(s), boron compound, and molybdenum compound included in the composition may be appropriately adjusted for improving moisturizing and water retention capability of moss depending on the kinds of compounds used to supply major or trace elements to moss, the hydrated/anhydrous state thereof, and the formulation form. For example, when calcium nitrate, a kind of metal nitrate, is in a hydrated state, a greater weight than anhydrous calcium nitrate may be required to supply the same amount of calcium; and when Fe-EDTA as an iron chelate compound is a liquid with 12.5% iron content (Fe-EDTA (12.5%)), a smaller weight may be required to supply the same amount of iron than a liquid Fe-EDTA having 11% iron content or Fe-DTPA having 10% iron content.

Accordingly, in designing the composition for moisturizing moss and improving water retention capability, the addition amounts of compounds may be appropriately controlled according to the kinds, states, and formulations of the compounds used for supplying each element.

In one embodiment, the composition is diluted 10-fold to 1,000-fold; for example, a diluted solution obtained by adding a composition obtained by mixing the A-part and B-part to an aqueous solvent and diluting 10-fold, 20-fold, 50-fold, 100-fold, 200-fold, 500-fold, or 1,000-fold may be brought into contact with moss, and more particularly, a diluted solution diluted 50-fold to 200-fold may be brought into contact with moss. If the dilution factor is too small, toxicity associated with local overcontact of nutrient elements to moss tissues may occur; if the dilution factor is too large, the nutrients for improving moisturizing and water retention capability may not be sufficiently delivered to the moss body.

In the present invention, the dilution may be based on volume ratio of the composition to the aqueous solvent, weight ratio, or weight of the composition to the volume of the aqueous solvent; for example, the composition may be diluted according to the volume ratio with an aqueous solvent.

In another aspect, the invention provides a method for moisturizing moss and improving water retention capability, the method comprising a contacting step of bringing the composition for moisturizing moss and improving water retention capability into contact with moss; wherein the composition comprises: an A-part including metal nitrate(s) and an iron chelate compound; and a B-part including metal nitrate(s), metal sulfate(s), phosphate(s), a boron compound, and a molybdenum compound.

As used herein, “contacting” means exposing moss to the composition for moisturizing moss and improving water retention capability according to the invention; the contacting may be carried out directly by spraying or applying the composition to the moss, or indirectly by treating the composition on a growth substrate such as soil or medium on which moss grows.

### Effect of Invention

According to the invention, the composition supplies water to moss to exhibit a moisturizing effect while enabling the moss to retain water for an extended period, thereby stably supplying, even under dry conditions, the water necessary for moss physiological activities and increasing efficiency of moss growth and reproduction.

### BRIEF DESCRIPTION OF DRAWINGS

FIG. 1 is a photograph showing the A-part and B-part constituting a composition according to an embodiment of the invention.

FIG. 2 is a photograph showing the degree of spreading of moss thalli (leaves) observed every 24 hours after Racomitirium lanuginosum (experimental group, treated with the composition prepared according to an embodiment of the invention) or Racomitirium lanuginosum (control group, treated with distilled water) was exposed to a dry environment (relative humidity≤30%, 25° C.). The red scale bar represents 0.1 mm, and the red arrows indicate the moss leaves that were subjected to specific angle measurements (FIG. 3).

FIG. 3 is a graph comparing results of measuring, every 24 hours, the thallus (leaf) angle of Racomitirium lanuginosum (experimental group treated with the composition) or Racomitirium lanuginosum (control group treated with distilled water) exposed to a dry environment (relative humidity≤30%, 25° C.).

### DETAILED DESCRIPTION OF EXEMPLARY EMBODIMENTS

The invention will be described in further detail with the following embodiments, which are provided for illustrative purposes and are not intended to limit the scope of the invention.

Unless otherwise indicated, “%” used throughout the specification to indicate concentration of a particular substance means (w/w) % for solid/solid, (w/v) % for solid/liquid, and (v/v) % for liquid/liquid

Unless otherwise specified, all numbers, values, and/or expressions used herein to express components, reaction conditions, and content of components should be understood as being modified by the term “about,” because such numbers are approximations that reflect various uncertainties inherent in measurement when obtaining such values from essentially different things.

When a numerical range is disclosed herein, the range is continuous and includes, unless otherwise specified, all values from the minimum to the maximum, inclusive.

As used in the specification, the term “or” is intended to be an inclusive “or,” not an exclusive “or,” unless otherwise specified or clear from the context. That is, “X comprises A or B” applies to any of the cases where X comprises A; X comprises B; or X comprises both A and B.

Throughout the specification, unless specifically stated to the contrary, when a part is said to “include” a component, it does not exclude the presence of other components but may further include them.

### Preparation Example: Preparation of a Composition for Promoting Spore Germination and Protonemal Growth of Moss

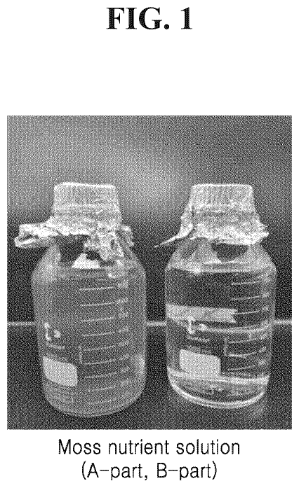

To prepare a nutrient solution composition that includes macronutrients (nitrogen, potassium, phosphorus, calcium, and magnesium) and micronutrients (iron, boron, manganese, zinc, copper, and molybdenum) required for spore germination and protonemal growth of moss, the A-part and B-part were prepared separately with the formulations shown in Table 1. A comparative photograph of the A-part and B-part prepared according to this Preparation Example is shown in FIG. 1.

TABLE 1

| Division | Compound name | Content (g/L) |
|---|---|---|
| A-part | Potassium nitrate (KNO₃) | 11 |
| | “Calcium nitrate tetrahydrate” (Ca(NO₃)₂•4H₂O) | 21 |
| | Iron-EDTA chelate (Fe-EDTA (12.5%)) | 1.538 |
| | Magnesium nitrate (Mg(NO₃)₂) | 23 |
| B-part | Potassium nitrate (KNO₃) | 11 |
| | Magnesium sulfate heptahydrate (MgSO₄•7H₂O) | 5 |
| | Ammonium dihydrogen phosphate (NH₄H₂PO₄) | 16.5 |
| | Boric acid (H₃BO₃) | 0.114 |
| B-part | Manganese sulfate monohydrate (MnSO₄•H₂O) | 0.081 |
| | Zinc sulfate heptahydrate (ZnSO₄•7H₂O) | 0.009 |
| | Copper sulfate pentahydrate (CuSO₄•5H₂O) | 0.004 |
| | Ammonium molybdate tetrahydrate | 0.001 |
| | ((NH₄)₆Mo₇O₂₄•4H₂O) | |

Thereafter, the prepared A-part and B-part were mixed to prepare a nutrient solution composition for promoting spore germination and protonemal growth of moss. The final composition was designated “MONS.”

### Example: Comparative Test of Moss Water Content Under Dry Conditions

A comparative test was performed on changes in moss water content when MoNS prepared according to the Preparation Example or distilled water was applied to moss.

Specifically, on a culture substrate with Racomitirium lanuginosum growing, a 100-fold diluted MoNS solution (experimental group) or distilled water (control group) was sprayed evenly and allowed to saturate the moss body completely for 12 hours. Thereafter, each culture substrate was placed in a chamber with an artificially created dry environment (relative humidity around 30% and 25±2° C.), and the angle of the moss leaves was measured every 24 hours. The greater the angle of leaves relative to the ground (approaching) 90°, the more deficient the water content in the moss body.

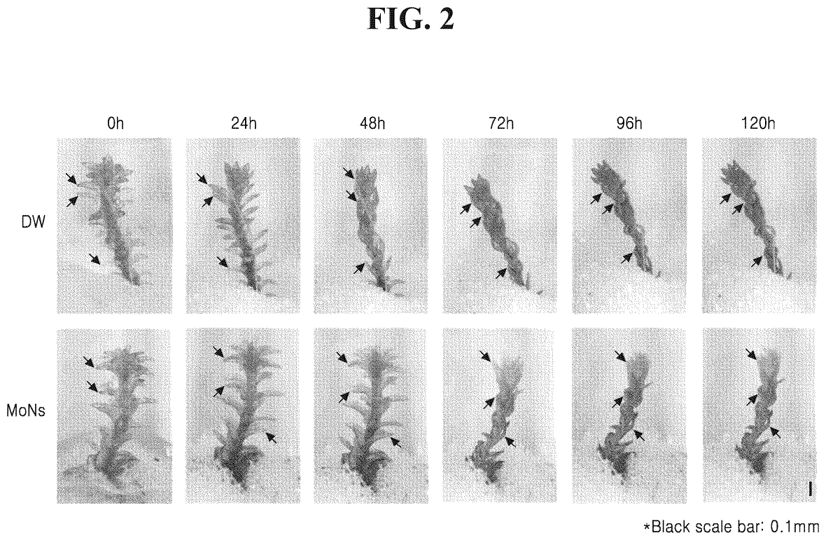

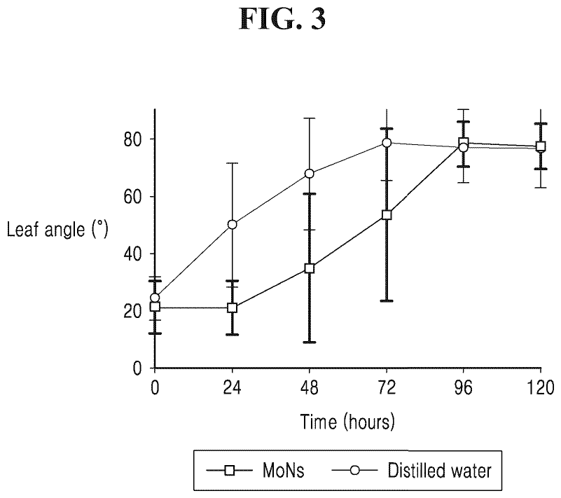

Leaf angle measurements were performed for five Racomitirium lanuginosum individuals per group (experimental and control), with three different positions per individual (corresponding to the red arrow points in FIG. 2), and photographs were taken from immediately after exposure to the dry environment until 5 days (120 hours) thereafter (FIG. 2). The leafangle measurement results are shown in Table 2 and FIG. 3.

TABLE 2

| | Exposure time under dry conditions | | | | | |
|---|---|---|---|---|---|---|
| | 0 h | 24 h | 48 h | 72 h | 96 h | 120 h |
| Control (distilled water) | 24.51° | 50.03° | 68.00° | 79.01° | 77.48° | 76.91° |
| Experimental (MoNS solution) | 21.38° | 21.28° | 35.10° | 53.75° | 78.42° | 77.61° |

In the control moss treated with distilled water, the leaf angle increased sharply as early as 24 hours after exposure to the dry environment, indicating a water-deficient morphology, whereas in the experimental moss treated with MoNS, the leaf angle began to increase gradually only after 48 hours.

Accordingly, the MoNS nutrient solution prepared according to the embodiments of the invention is considered to suppress water loss from the moss body more effectively than water alone and to maintain water within the moss body for a longer period, thereby effectively moisturizing moss and improving its water retention capability.

1. A composition for moisturizing moss and improving water retention capability, comprising:
an A-part including metal nitrate(s) and an iron chelate compound; and
a B-part including metal nitrate(s), metal sulfate(s), phosphate(s), a boron compound, and a molybdenum compound.

2. The composition of claim 1, wherein the metal nitrate(s) of the A-part are one or more anhydrous or hydrated forms selected from potassium nitrate (KNO₃), calcium nitrate (Ca(NO₃)₂), and magnesium nitrate (Mg(NO₃)₂), and the iron chelate compound is one or more selected from FeEDTA, FeDTPA, FeEDDHA, FeHEEDTA, ferric citrate, and ammonium ferric citrate.

3. The composition of claim 2, wherein the A-part includes 40 to 80 g/L of the metal nitrate(s) and 0.9 to 3.5 g/L of the iron chelate compound.

4. The composition of claim 3, wherein the metal nitrate(s) of the A-part include 8 to 15 g/L of potassium nitrate, 12 to 24 g/L of calcium nitrate, and 21 to 42 g/L of magnesium nitrate.

5. The composition of claim 1, wherein the metal nitrate(s) of the B-part are potassium nitrate, the metal sulfate(s) are one or more anhydrous or hydrated forms selected from magnesium sulfate (MgSO₄), manganese sulfate (MnSO₄), zinc sulfate (ZnSO₄), and copper sulfate (CuSO₄), the phosphate(s) are one or more selected from ammonium dihydrogen phosphate (NH₄H₂PO₄), diammonium hydrogen phosphate ((NH₄)₂HPO₄), and potassium dihydrogen phosphate (KH₂PO₄), the boron compound is an anhydrous or hydrated forms of sodium tetraborate (borax, Na₂B₄O₇) or boric acid (H₃BO₃), and the molybdenum compound is an anhydrous or hydrated forms of ammonium molybdate ((NH₄)₆Mo₇O₂₄) or sodium molybdate (Na₂MoO₄).

6. The composition of claim 5, wherein the B-part includes 8 to 15 g/L of the metal nitrate(s), 2 to 7 g/L of the metal sulfate(s), 15 to 25 g/L of the phosphate(s), 0.05 to 0.2 g/L of the boron compound, and 0.0008 to 0.0016 g/L of the molybdenum compound.

7. The composition of claim 6, wherein the metal sulfate(s) of the B-part include 2 to 7 g/L of magnesium sulfate, 0.05 to 0.1 g/L of manganese sulfate, 0.003 to 0.012 g/L of zinc sulfate, and 0.002 to 0.006 g/L of copper sulfate.

8. The composition of claim 1, wherein the composition is diluted 10-fold to 1,000-fold.

9. A method for moisturizing moss and improving water retention capability, comprising a contacting step of bringing a composition for moisturizing moss and improving water retention capability into contact with moss,
wherein the composition comprises:
an A-part including metal nitrate(s) and an iron chelate compound; and
a B-part including metal nitrate(s), metal sulfate(s), phosphate(s), a boron compound, and a molybdenum compound.
